(19) United States
(12) Patent Application Publication
(10) Pub. No.: US 2016/0056672 A1
(43) Pub. Date: Feb. 25, 2016

(54) PERMANENT MAGNET MOTOR

(71) Applicants: GUANGDONG WELLING MOTOR MANUFACTURING CO., LTD., Foshan, Guangdong (CN); MIDEA WELLING MOTOR TECHNOLOGY (SHANGHAI) CO., LTD., Shanghai (CN)

(72) Inventors: Bang Yuan, Shanghai (CN); Fei Wang, Shanghai (CN); Wensheng Gong, Shanghai (CN); Jintao Chen, Shanghai (CN); Z.Q. Zhu, Shanghai (CN)

(21) Appl. No.: 14/781,493

(22) PCT Filed: Nov. 22, 2013
(86) PCT No.: PCT/CN2013/087708

§ 371 Date: Sep. 30, 2015

(30) Foreign Application Priority Data
May 13, 2013 (CN) 201310175366.8

(51) Int. Cl. H02K 1/14; H02K 1/27; H02K 1/02

(52) U.S. Cl. CPC H02K 1/146; H02K 1/02; H02K 1/2766

(57) ABSTRACT

A permanent magnet motor is provided. The permanent magnet motor includes a stator having a central hole, a rotor disposed in the central hole, the stator core includes a plurality of winding grooves and a plurality of winding teeth each disposed between adjacent winding grooves, each of the winding teeth includes a pole shoe disposed at an inner end thereof, and the pole shoe has an inner end surface facing the rotor and including a circular arc segment in a middle of the inner end surface, the central hole has a center, the radian of the circular arc segment is greater than that of the central hole, and the circle center of the circular arc segment does not coincide with the center of the central hole.

### CROSS REFERENCE TO RELATED APPLICATION

This application claims priority and benefits of Chinese Patent Application No. 201310175366.8, filed with State Intellectual Property Office, P. R. C. on May 13, 2013, the entire content of which is incorporated herein by reference.

### FIELD

Embodiments of the present disclosure generally relate to a permanent magnet motor.

### BACKGROUND

With different permanent magnet materials used for the rotor of the permanent magnet motor, the motor used in the compressor may be classified into two types: a motor with Nd—Fe—B permanent magnetic material and a motor with ferrite permanent magnetic material.

In the related art, the permanent magnet material used for the rotor of the permanent magnet motor usually is rare earth Nd—Fe—B, as described in Chinese patents CN102222995A and CN 101421905A. However, because rare earth materials are scarce, the motor is expensive.

Although rotors of the motors disclosed in Chinese patents CN1416204A and CN202068244U adopt ferrite structures, the ferrite structure has defects of demagnetization so as to cause a low utilization rate of magnetic energy and a dramatically decreasing of the power index of the motor, and the reliability of the ferrite structure may not be guaranteed.

In addition, the electromagnetic noise of the motor of the compressor is caused mainly by the large cogging torque, the non-sinusoidal counter electromotive force and the large torque ripple etc.

There are many studies and researches on the motor, such as adopting a surface-mounted permanent magnet motor, inclining the groove of the stator, inclining the pole of the rotor and forming a small notch in the inner end surface of a stator. Although these methods may reduce the cogging torque and the torque ripple of the motor so as to reduce the vibration and noise of the motor, these methods have defects of complex manufacturing processes, high cost and low performance of the motor.

### SUMMARY

Embodiments of the present disclosure seek to provide a permanent magnet motor with a good performance and a low cost.

Accordingly, a permanent magnet motor according to embodiments of the present invention is provided, including: a rotor, including: a rotor core having a plurality of receiving recesses, a plurality of permanent magnets received in the receiving recesses; and a stator having a central hole in which the rotor is disposed, including: a stator core having a plurality of winding grooves and a plurality of winding teeth each disposed between adjacent winding grooves, wherein each of the winding teeth includes a pole shoe disposed at an inner end thereof, the pole shoe of each winding tooth having a pair of wedged portions extending toward two winding grooves adjacent to the each winding tooth respectively, the pole shoe has an inner end surface facing the rotor and including a circular arc segment in a middle of the inner end surface, and a plurality of stator windings received in the winding grooves respectively, wherein a circle center of each of the circular arc segments of the winding teeth is deviated from a center of the central hole, and a radius of the central hole is a distance from the center of the central hole to a point of the circular arc segment farthest from the center of the central hole.

In some embodiments, the plurality of circular arc segments are not located on a same circumference, and circle centers of the plurality of the circular arc segments are arranged around the center of the central hole.

In some embodiments, the circle centers of the plurality of the circular arc segments are located on a same circumference, and a center of the circumference coincides with the center of the central hole.

In some embodiments, the inner end surface of the pole shoe further includes two inclined segments connected to two ends of the circular arc segment respectively, and the inclined segment is substantially straight or arc-shaped and extends obliquely outwards.

In some embodiments, a ratio of a distance between the center of the central hole and the circle center of the circular arc segment to a diameter of the central hole ranges from 0.1 to 0.3.

In some embodiments, a central angle whose vertex is the center of the central hole and whose sides pass through two free ends of the inner end surface of the pole shoe is θ1, and a central angle whose vertex is the center of the central hole and whose sides pass through two ends of the circular arc segment of the inner end surface is θ2, in which a ratio of θ2 to θ1 ranges from 0.55-0.95.

In some embodiments, the permanent magnet is made of ferrite magnetic steel.

In some embodiments, the receiving recess is circular arc shaped, and a central angle whose vertex is a circle center of the receiving recess and whose sides pass through two ends of the permanent magnet received in the receiving recess is θ5, in which 90°≦θ5≦160°.

In some embodiments, two extending grooves disposed at two ends of the receiving recess respectively extend toward each other, a central angle whose vertex is the center of the central hole and whose sides pass through an outer edge of each end of the receiving recess and an inner edge of the extending groove extended from the each end of the receiving recess is θ3, and a central angle whose vertex is the center of the central hole and whose sides pass through the outer edge and an inner edge of each end of the receiving recess is θ4, in which θ4<θ3<360/4 P, and P is the number of pole pairs of the permanent magnet motor.

Compared with the permanent magnet motor in the related art, the performance of the permanent magnet motor according to embodiments of the present invention is effectively improved due to the non-coincidence of the radians of the circular arc segment and the central hole, and the processing requirements for the rotor is reduced because the only part required to be processed is the stator.

In addition, in the condition of taking full advantage of magnetic energy and reducing the leakage magnetic field, by reasonably selecting a value range of the Le, θ1, θ2, θ3, θ4 or θ5, the permanent magnet motor according to embodiments of the present invention may generate a sinusoidal wave magnetic field in a nonuniform air gap, reduce the cogging torque, improve the induced voltage wave in the windings, reduce the ripple torque and the torque ripple so as to achieve a smooth operation of the motor system.

Moreover, the permanent magnet motor according to embodiments of the present invention also has a low cost, a light vibration, a low noise and a high efficiency.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic view of a permanent magnet brushless synchronous motor according to embodiments of the present embodiment;

FIG. 2 is a schematic view of a stator of a permanent magnet motor according to embodiments of the present invention;

FIG. 3 is a partial enlarged view of a pole shoe of a permanent magnet motor according to embodiments of the present invention;

FIG. 4 is a schematic view of a rotor of a permanent magnet motor according to embodiments of the present invention;

FIG. 5 is a partial enlarged view of a receiving recess of a permanent magnet motor according to embodiments of the present invention.

### DETAILED DESCRIPTION

Reference will be made in detail to embodiments of the present disclosure. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation, and the relative terms also do not limit the present invention.

In the description of the present disclosure, unless specified or limited otherwise, it should be noted that, terms “mounted,” “connected” and “coupled” may be understood broadly, such as electronic connection or mechanical connection, inner communication between two elements, direct connection or indirect connection via intermediary. These having ordinary skills in the art should understand the specific meanings in the present disclosure according to specific situations.

It should be particularly noted that, in the description of the present invention, “inner” indicates a direction towards to a center of the rotor, and “outer” indicates a direction away from a center of the rotor.

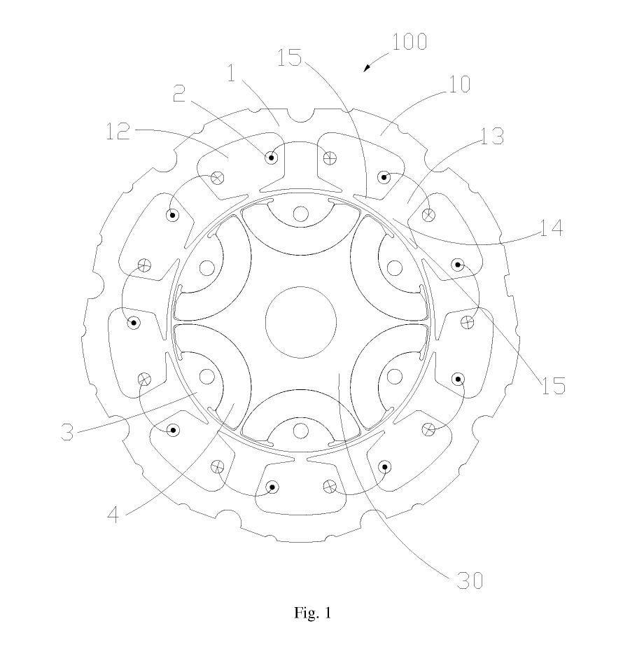

As shown in FIGS. 1 to 5, the permanent magnet motor 100 includes a stator 10 and a rotor 30 disposed in a central hole 20 of the stator 10. The central hole 20 has a center O. A certain air gap is formed between the stator 10 and the rotor 30. The permanent magnet motor 100 according to embodiments of the present invention may be a permanent magnet brushless motor, a permanent magnet synchronous motor or a permanent magnet brushless synchronous motor.

As shown in FIG. 1, the stator 10 includes a stator core 1 and a plurality of stator windings 2. The stator core 1 has a plurality of winding grooves 12 configured to receive the stator windings 2 respectively and a plurality of winding teeth 13 disposed between adjacent winding grooves 12 respectively. Each of the winding teeth 13 includes a pole shoe 14 disposed at an inner end of the winding tooth 13, and the pole shoe 14 of each winding tooth 13 has a pair of wedged portions 15 extending toward two winding grooves 12 adjacent to the each winding tooth 13 respectively. A width (a distance between free ends of a pair of wedged portions 15) of the pole shoe 14 is the maximum width of the winding tooth 13, and a width (a radial length of the wedged portion 15) of the wedged portion 15 is gradually decreased with closing to the corresponding winding groove 12, in other words, a width of the free end of the wedged portion 15 is the minimum width of the wedged portion 15.

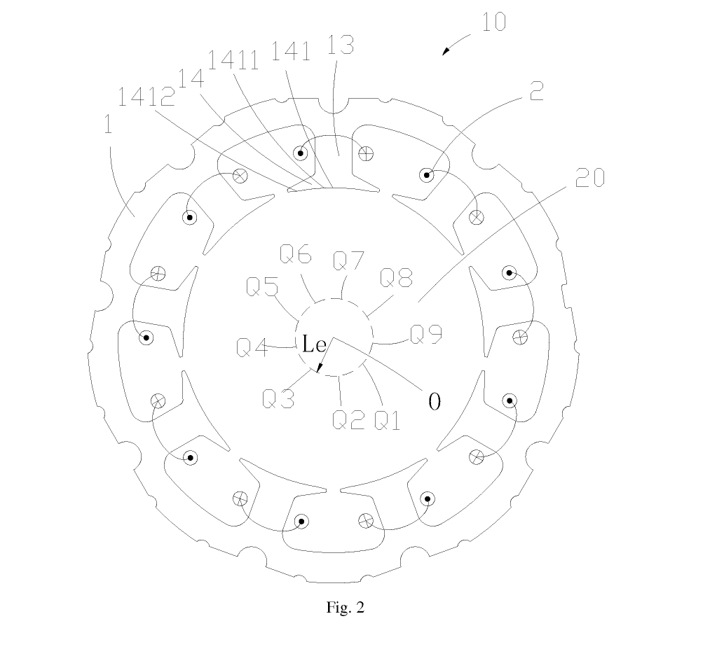

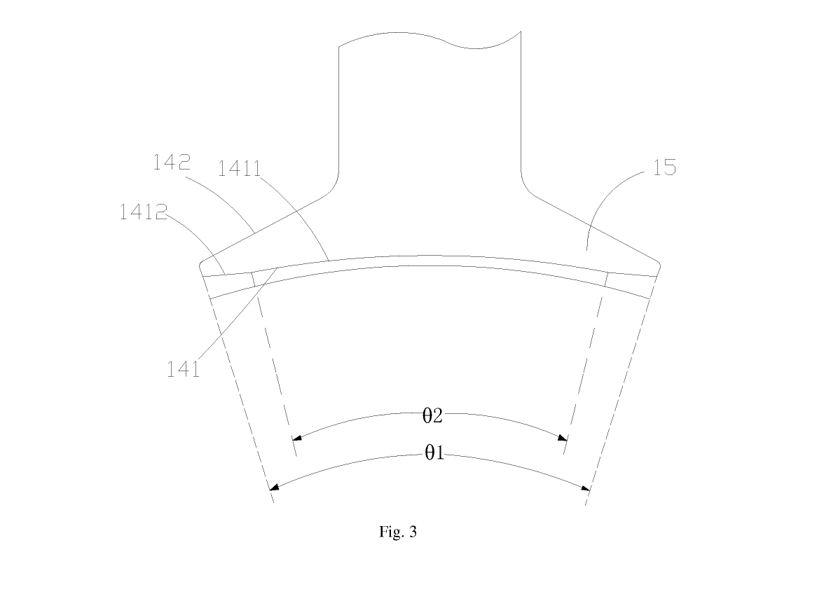

As shown in FIG. 2 and FIG. 3, the pole shoe 14 has an inner end surface 141 facing the rotor 30 and an outer end surface 142 opposite to the inner end surface 141, and the inner end surface 141 includes a circular arc segment 1411 in a middle of the inner end surface 141 and two inclined segments 1412 connected to two ends of the circular arc segment 1411 respectively. The inclined segment 1412 extends obliquely outwards, i.e., a free end of the inclined segment 1412 of the pole shoe 14 obliquely extends toward the interior of the winding groove 12 with respect to two ends of the circular arc segment 1411. The inclined segment 1412 may be substantially straight or arc-shaped.

A central angle whose vertex is the center O of the central hole 20 and whose sides pass through two free ends of the inner end surface 141 (including the circular arc segment 1411 and two inclined segments 1412) of the pole shoe 14 is θ1, and a central angle whose vertex is the center O of the central hole 20 and whose sides pass through two ends of the circular arc segment 1411 of the inner end surface 141 is θ2, in which a ratio of θ2 to θ1 ranges from 0.55-0.95.

As shown in FIG. 2, a radian of the circular arc segment 1411 is greater than that of the central hole 20, and each of the circular arc segments 1411 has its own circle center Q (a plurality of the circle centers Q of the plurality of the circular arc segments 1411 is numbered sequentially as Q1, Q2, Q3, Q4 . . . Qn) which does not coincide with the center O of the central hole 20. In other words, a circle center Q of each of the circular arc segments 1411 of the winding teeth 13 is deviated from the center Q of the central hole 20. The plurality of circular arc segments 1411 are not located on a same circumference.

The plurality of the circle centers Q of the plurality of the circular arc segments 1411 is arranged around the center O of the central hole.

Alternatively, the plurality of the circle centers Q are located on a same circumference and a center of the circumference coincides with the center O of the central hole 20, i.e., the plurality of the circle centers Q are arranged on the same circumference (indicated by a circumference formed by a dotted line in FIG. 2) whose center is the center O of the central hole 20.

A distance between the circle center Q and the center O is Le (i.e., a radius of the circumference formed by the dotted line), a radius of the central hole 20 is a distance from the center O of the central hole 20 to a point of the circular arc segment 1411 farthest from the center O of the central hole 20, and a ratio of the distance Le to a diameter of the central hole 20 ranges from 0.1 to 0.3.

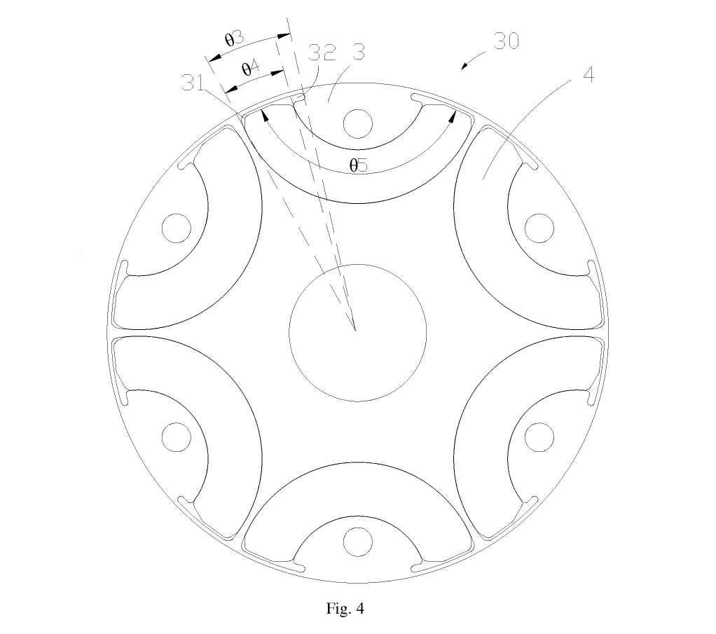

As shown in FIG. 4, the rotor 4 includes a rotor core 3 having a plurality of receiving recesses 31 and permanent magnets 4 received in the receiving recesses 31. The permanent magnet 4 is made of ferrite magnetic steel material.

The receiving recess 31 is circular arc-shaped and radially magnetized, and a central angle whose vertex is a circle center (not shown) of the receiving recess 31 and whose sides pass through two ends of the permanent magnet 4 received in the receiving recess 31 is θ5, preferably, 90°≦θ5≦160°.

In other embodiments, the receiving recess 31 may have a U-type, V-type or other irregular shape.

As shown in FIG. 4 and FIG. 5, two extending grooves 32 disposed at two ends of the receiving recess 31 respectively are extended toward each other, a central angle whose vertex is the center O of the central hole 20 and whose sides pass through an outer edge of each end of the receiving recess 31 and an inner edge of the extending groove 32 extended from the each end of the receiving recess 31 is θ3, and a central angle whose vertex is the center O of the central hole 20 and whose sides pass through the outer edge and an inner edge of each end of the receiving recess 31 is θ4, in other words, the central angle of a width of the receiving recess 31 relative to the center O is θ4, in which θ4<θ3<360/4 P, P is the number of pole pairs of the permanent magnet motor, and a ratio of the number of pole pairs of the permanent magnet motor to the number of the winding grooves 12 of the stator 10 is 2:3.

In the condition of taking full advantage of magnetic energy and reducing the leakage magnetic field, by reasonably selecting a value range of the Le, θ1, θ2, θ3, θ4 or θ5, the permanent magnet motor according to embodiments of the present invention may generate a sinusoidal wave magnetic field in a nonuniform air gap, reduce the cogging torque, improve the induced voltage wave in the windings and reduce the ripple torque and the torque ripple so as to achieve a smooth operation of the motor system.

Moreover, the permanent magnet motor according to embodiments of the present invention also has a low cost, a light vibration, a low noise and a high efficiency.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A permanent magnet motor, comprising:
a rotor, comprising:
a rotor core having a plurality of receiving recesses,
a plurality of permanent magnets received in the receiving recesses; and
a stator having a central hole in which the rotor is disposed, and comprising:
a stator core having a plurality of winding grooves and a plurality of winding teeth each disposed between adjacent winding grooves, wherein each of the winding teeth comprises a pole shoe disposed at an inner end thereof, the pole shoe of each winding tooth having a pair of wedged portions extending toward two winding grooves adjacent to the each winding tooth respectively, the pole shoe has an inner end surface facing the rotor and comprising a circular arc segment in a middle of the inner end surface,
a plurality of stator windings received in the winding grooves respectively,
wherein a circle center of each of the circular arc segments of the winding teeth is deviated from a center of the central hole, and a radius of the central hole is a distance from the center of the central hole to a point of the circular arc segment farthest from the center of the central hole.

2. The permanent magnet motor according to claim 1, wherein the plurality of circular arc segments are not located on a same circumference, and circle centers of the plurality of the circular arc segments are arranged around the center of the central hole.

3. The permanent magnet motor according to claim 2, wherein the circle centers of the plurality of the circular arc segments are located on a same circumference and a center of the circumference coincides with the center of the central hole.

4. The permanent magnet motor according to claim 1, wherein the inner end surface of the pole shoe further comprises two inclined segments connected to two ends of the circular arc segment respectively, and the inclined segment is substantially straight or arc-shaped and extends obliquely outwards.

5. The permanent magnet motor according to claim 1, wherein a ratio of a distance between the center of the central hole and the circle center of the circular arc segment to a diameter of the central hole ranges from 0.1 to 0.3.

6. The permanent magnet motor according to claim 1, wherein a central angle whose vertex is the center of the central hole and whose sides pass through two free ends of the inner end surface of the pole shoe is θ1, and a central angle whose vertex is the center of the central hole and whose sides pass through two ends of the circular arc segment of the inner end surface is θ2, in which a ratio of θ2 to θ1 ranges from 0.55-0.95.

7. The permanent magnet motor according to claim 1, wherein the permanent magnet is made of ferrite magnetic steel.

8. The permanent magnet motor according to claim 1, wherein the receiving recess is circular arc shaped, and a central angle whose vertex is a circle center of the receiving recess and whose sides pass through two ends of the permanent magnet received in the receiving recess is θ5, in which 90°≦θ5≦160°.

9. The permanent magnet motor according to claim 1, wherein two extending grooves disposed at two ends of the receiving recess respectively extend toward each other, a central angle whose vertex is the center of the central hole and whose sides pass through an outer edge of each end of the receiving recess and an inner edge of the extending groove extended from the each end of the receiving recess is θ3, and a central angle whose vertex is the center of the central hole and whose sides pass through the outer edge and an inner edge of each end of the receiving recess is θ4, in which θ4<θ3<360/4 P, and P is the number of pole pairs of the permanent magnet motor.
